(19) United States
(12) Patent Application Publication
(10) Pub. No.: US 2014/0367014 A1
(43) Pub. Date: Dec. 18, 2014

(54) MOTOR VEHICLE ANTI-SKID CRAWLER

(71) Applicant: Xianglin LIAN, Lanzhou City (CN)

(72) Inventor: Xianglin LIAN, Lanzhou City (CN)

(21) Appl. No.: 13/919,360

(22) Filed: Jun. 17, 2013

(51) Int. Cl. B60C 27/20; B60C 27/06

(52) U.S. Cl. CPC B60C 27/20; B60C 27/06
USPC 152/225 R

(57) ABSTRACT

The present invention discloses a motor vehicle anti-skid crawler comprising multiple sets of anti-skid dental plates surrounding the outer circumference of the tire and more circumferential links which chain the anti-skid dental plates in turn together, wherein: each set of the anti-skid dental plates includes a main shift-force plate, and a plurality of bifurcated shift-force plates which are formed by respectively extending outwardly at a angle from each end of the main shift-force plate. The improved anti-skid crawler dental plate of the present invention, the cross section of which inserted into the ice-snow, desert, sludge and marsh is huge, makes the pushing torque of the running vehicle to the ground very strong, and makes the vehicle run very speedily and smoothly.

### FIELD OF THE INVENTION

The present invention relates to an anti-skid crawler, and particularly to a motor vehicle anti-skid crawler which is portable, adaptable to a variety of road conditions and applicable to various vehicle types.

### RELEVANT BACKGROUND

Currently, in many countries around the world, the conventional automobile anti-skid chains are broadly used to prevent various types of motor vehicles slipping when travelling in ice-snow, sludge, rubble or desert for over 90 years. The conventional automobile anti-skid chains have following disadvantages:

1. It's bulky and difficult to assemble;

2. It's unobvious to prevent lateral slippage on ice-snow curve;

3. It only can be used in ice-snow road and cannot be used in sludge road, rubble road and desert.

4. It causes the wear of the tire, extremely slow vehicle speed, excessive vibration, the wear of road surface.

Chinese patent NO.ZL03144057.6 disclosed a motor vehicle anti-skid crawler, partially solved the above-mentioned problems and also have the following notable disadvantages:

In functional aspects: \textcircled{1} The degree of eating into the ice-snow is not great, the reaction force to the ground is poor on the ice-snow road segment, it takes off slowly; \textcircled{2} The force against side-slip on the ice-snow curve is insufficient; \textcircled{3} It's difficult to successfully pass through the sludge road segment and desert.

In structural aspects: \textcircled{1} The difficulty of the dental plate manufacturing process is too large; \textcircled{2} The debugging of dynamic balance is complex; \textcircled{3} The total weight is too heavy, and it is inconvenient to carry; \textcircled{4} The vehicle types to which it is applicable are limited.

### SUMMARY OF THE INVENTION

The primary object of the present invention is to overcome the drawbacks of the aforementioned functions and the complexity in structure, and to provide a novel anti-skid and anti-subsidence crawler which is adaptable to the various road conditions and is convenient to handle.

To achieve the above object, the present invention provides a motor vehicle anti-skid crawler comprising multiple sets of anti-skid dental plates surrounding the outer circumference of the tire and more circumferential links which chain the anti-skid dental plates in turn together, wherein: each set of the anti-skid dental plates includes a main shift-force plate, and a plurality of bifurcated shift-force plates which are formed by respectively extending outwardly at a angle from each end of the main shift-force plate, and the ends of the bifurcated shift-force plates in each sides of the main shift-force plate are connected by a strength coupling plate, the strength coupling plates corresponding to the two adjacent sets of anti-skid dental plates are connected by the circumferential link; each strength coupling plate is provided with a through hole in the middle part which is configured for coupling of a guiding movable rod, the guiding movable rod is further connected with a axial radial links, two wire ropes passes respectively through all the radial links in both sides of the tire and then couple with two turn buckles.

Furthermore, the bifurcated shift-force plate is a triangular cross-sectional body and a triangle body is fixed at the end of the bifurcated shift-force plate, wherein the top end of the triangle body is lower than that of the bifurcated shift-force plate. The triangular zone formed among the two bifurcated shift-force plates in each side of the main shift-force plate and the corresponding strength coupling plate is an isosceles triangle. The main shift-force plate is a trapezoid cross-sectional solid plate body, the top end of the main shift-force plate is provided with a plurality of triangular tooth.

The advantages of the present invention are:

1. The improved anti-skid crawler dental plate, on which the symmetrical four bifurcated shift-force plates form a triangle zone with space to the ground, firmly sticks to the ground so that the vehicle does not rock and shake in driving;

2. The triangular tooth heads of multiple small triangular opening on the main shift-force plate which is in dental plates of the improved anti-skid crawler, make the vehicle take off speedily and rapidly with non-skid, and run very smoothly and forcibly in the thick ice and heavy snow;

3. Both the triangle body on the upper end of two sides of strength coupling plate of the improved anti-skid dental plate 1 and the tip of the bifurcated shift-force plate which is higher than the triangle body make the sideslip completely disappear when the vehicle overcomes the centrifugal force in the curve of the thick ice and heavy snow, sludge road surface, i.e., no sideslip in curve;

4. The improved anti-skid crawler dental plate, the cross section of which inserted into the ice-snow, desert, sludge and marsh is huge, makes the pushing torque of the running vehicle to the ground very strong, and makes the vehicle run very speedily and smoothly;

5. The improved anti-skid dental plate, which has extremely simple manufacturing process, light weight and elegant appearance, can be applicable to various types of vehicles, which greatly reduced the production cost of the crawlers.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 is a schematic view of the motor vehicle anti-skid crawler which is mounted on a tire according to one embodiment of the present invention;

FIG. 2 is a front schematic view of the anti-skid dental plate according to one embodiment of the present invention;

FIG. 3 is a left side view of FIG. 2;

FIG. 4 is a top view of FIG. 2;

FIG. 5 is a cross-sectional view along line A-A of FIG. 2;

FIG. 6 is a schematic view of an assembly way of the double-end turn buckle according to one embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

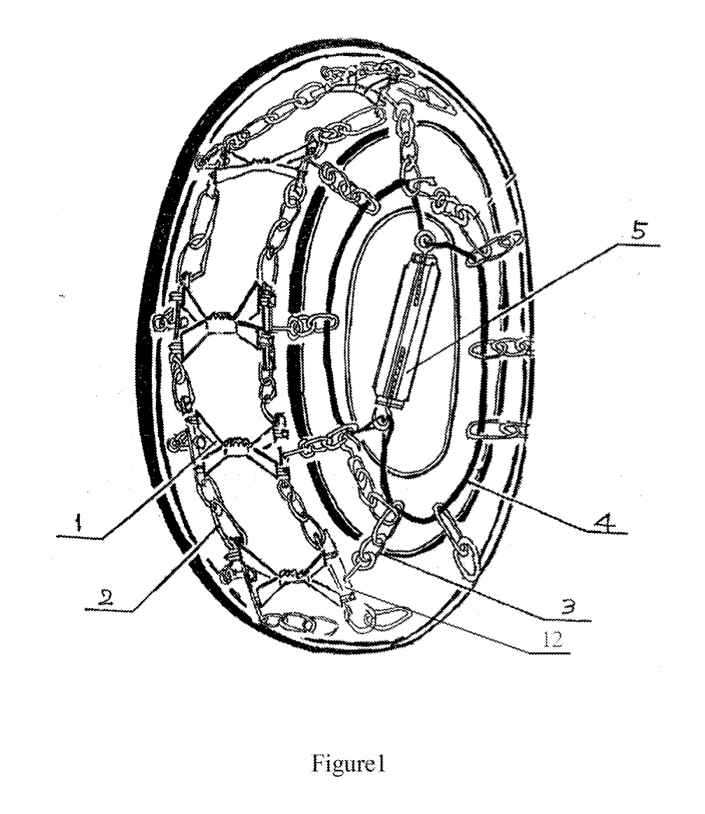

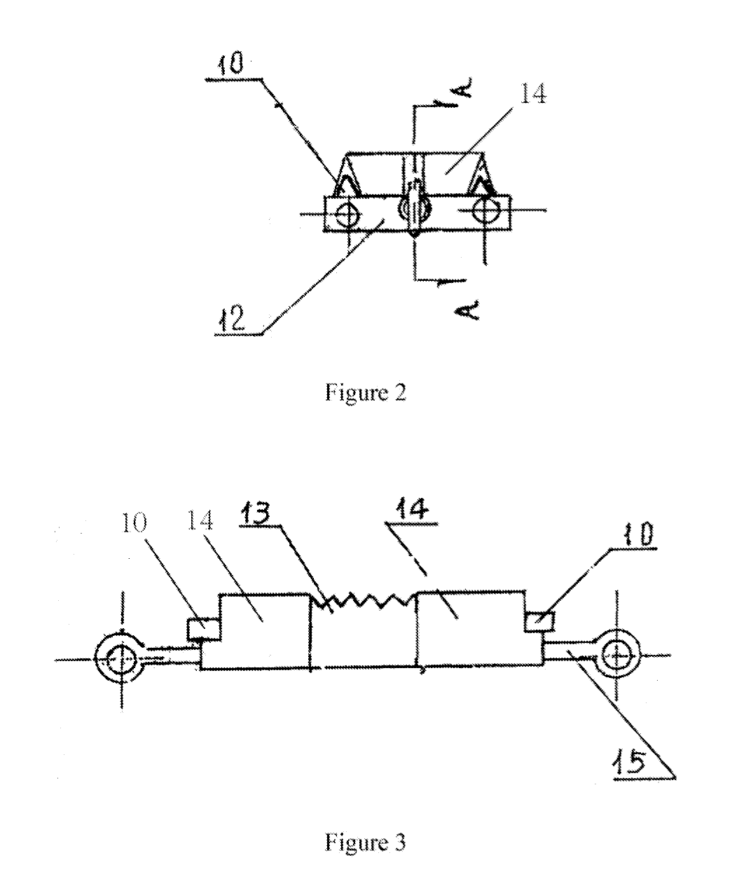

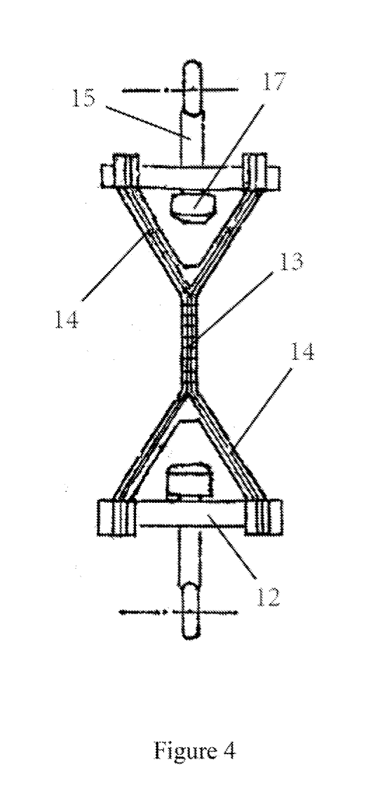

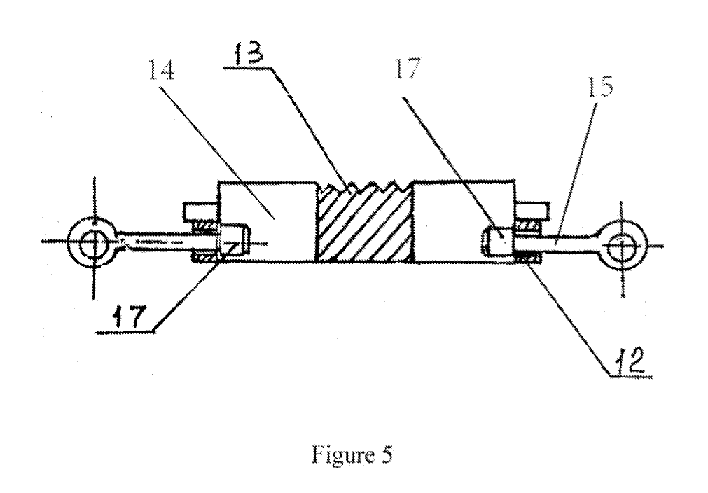

As shown in FIGS. 1-5, the motor vehicle anti-skid crawler of the present invention includes multiple sets of anti-skid dental plates 1 surrounding the outer circumference of a tire and more circumferential links 2 which chain together the anti-skid dental plates 1 together in turn. Each set of the anti-skid dental plates 1 includes a main shift-force plate 13 and a plurality of the bifurcated shift-force plates 14 which are formed by respectively extending outwardly at a angle from the each end of the main shift-force plate 13, and the ends of the bifurcated shift-force plates 14 in each sides of the main shift-force plate 13 are connected by a strength coupling plate 12, the strength coupling plates 12 corresponding to the two adjacent sets of anti-skid dental plates 1 are connected by the circumferential link 2.

In one embodiment of the present invention, in each side of the main shift-force plate 13, there are two bifurcated shift-force plates 14 extending from each end of the main shift-force plate 13, and the two bifurcated shift-force plates 14 are symmetrically arranged, the angle between the two bifurcated shift-force plates 14 in each side is between 30 degrees and 150 degrees, preferably 90 degrees. The triangular space formed between the bifurcated shift-force plate 14 in each side and the corresponding strength coupling plate 12 is an isosceles triangle which is perpendicular to the longitudinal axis. The symmetrical four bifurcated shift-force plates 14 form a triangle zone with space to the ground, firmly sticks to the ground so that the vehicle does not rock and shake in driving.

A triangle body 10 is fixed at the end of the bifurcated shift-force plate 14. Also, the bifurcated shift-force plate 14 is a triangular cross-sectional entity and provided coaxially with the triangle body 10. The top end of triangle body 10 is lower than that of the bifurcated shift-force plate 14. Both the triangle body 10 on the upper end of two sides of strength coupling plate 12 and the tip of the bifurcated shift-force plate 14 which is higher than the triangle body 10 make the sideslip completely disappear when the vehicle overcomes the centrifugal force in the curve of the thick ice and heavy snow, sludge road surface, i.e. no sideslip in curve road.

The main shift-force plate 13 is a trapezoid solid plate body, and the top end of the main shift-force plate 13 is provided with a plurality of triangular tooth, which make the vehicle take off speedily and rapidly with non-skid and run very smoothly and forcibly in the thick ice and heavy snow.

In the aspect of assembly, at the center and both ends of the strength coupling plate 12 there are three through hole. The central through hole is configured to let a guiding movable rod 15 to pass through, the tail of the guiding movable rod 15 is hinged on the strength coupling plate 12, the head of the guiding movable rod 15 is a circular ring. The movement space of the guiding movable rod 15 can be rotated freely. As shown in FIG. 5, the tail of the guiding movable rod 15 firmly has a sleeve 17 welded on, and the outer diameter of the sleeve is larger than the central through hole of the strength coupling plate 12. The through holes at both ends of the strength coupling plate 12 are configured to let the circumferential link 2 pass through.

As shown in FIG. 1, the anti-skid dental plates 1 are distributed uniformly around the tire. The connection manner between any two adjacent plates 1 is: firstly, the both ends of the circumferential link 2 in the circumferential direction are respectively connected to through holes at both ends of the strength coupling plate 12, then two circumferential links 2 connect with the anti-skid dental plates 1 in series along the circumference; secondly, one end of the radial links 3 whose number is same as the anti-skid dental plates 1 is respectively connected to the circular ring of the head of guiding movable rod 15, while the two wire ropes 4 pass through the free ends of the radial links 3 one by one, and both ends of each wire rope are coupled firmly, finally the radial links 3 at both sides are connected together to form a strong circumference of the wire rope.

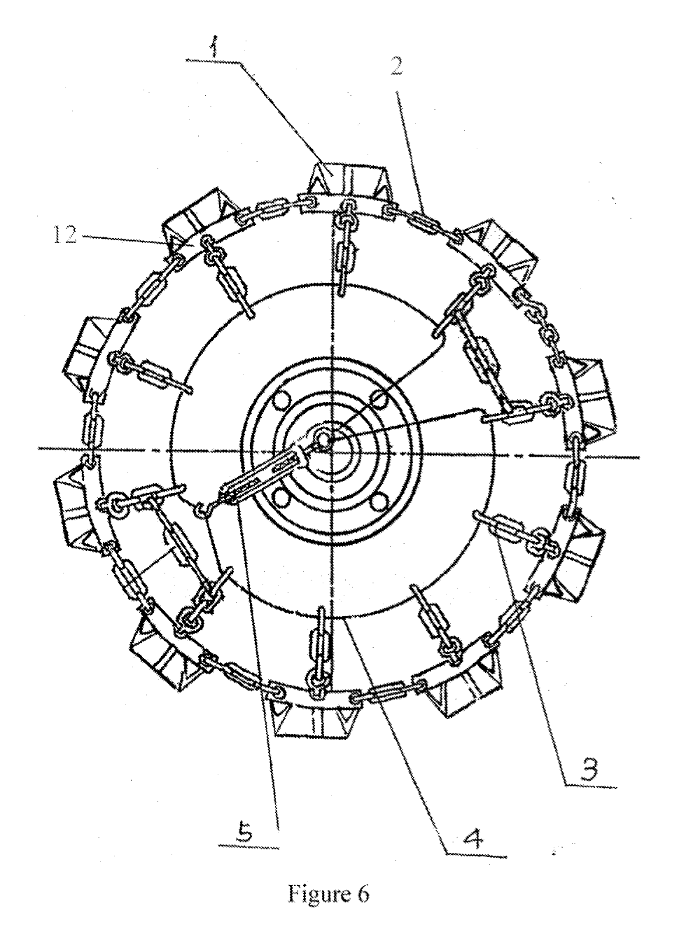

As shown in FIG. 6, for small-sized motor vehicle, the turn buckles 5 can be assembled by the following manner: The center portion of the double turn buckles 5 is a hollow strip steel part (i.e., petal basket), at both ends of which a positive and a negative female thread are screwed into a screw rod (with corresponding positive and negative buckles) respectively, wherein the head portion of one screw rod is provided with a ring, the head portion of another screw rod is provided with a hook, then the ring and the hook are respectively coupled to the wire ropes 4 at the inner and outer sides of the tire, when rotating the petal basket of the turn buckle 5, it can tighten the wire ropes 4, and at the same time the anti-skid dental plates 1 are firmly fixed to the circumference of the tire such that they never loosen and fall out, also it has no effect for high speed travel. For heavy vehicle, there are symmetrical eyelets on the steel ring of its wheel web, two wire ropes 4 at the inner and outer sides of the tire can pass through the eyelets of steel ring, following the cross-docking with the turn buckle 5, then the wire ropes are tightened.

The material of the anti-skid crawler of the present invention may be aluminum alloy, medium-carbon steel or carbon steel.

In the present invention, the cross section that the anti-skid crawler inserted into the ice-snow, desert, sludge and marsh is large and, which makes the pushing torque of the running vehicle to the ground be strong, and makes the vehicle run very speedily and smoothly. Also, the anti-skid crawler is extremely simple manufactured, light weight and elegant appearance, can be applicable to various types of vehicle, which greatly reduced the production cost of crawlers.

While there have been described above the principles of the present invention in conjunction with a lateral stability system, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicant hereby reserves the right to formulate new claims to such features and/or combinations of such features during the prosecution of the present application or of any further application derived therefrom.

We claim:

1. A motor vehicle anti-skid crawler comprising multiple sets of anti-skid dental plates (1) surrounding the outer circumference of the tire and more circumferential links (2) which chain the anti-skid dental plates (1) in turn together, wherein:
each set of the anti-skid dental plates (1) includes a main shift-force plate (13), and a plurality of bifurcated shift-force plates (14) which are formed by respectively extending outwardly at a angle from each end of the main shift-force plate (13), and the ends of the bifurcated shift-force plates (14) in each sides of the main shift-force plate (13) are connected by a strength coupling plate (12), the strength coupling plates (12) corresponding to the two adjacent sets of anti-skid dental plates (1) are connected by the circumferential link (2);
each strength coupling plate (12) is provided with a through hole in the middle part which is configured for coupling of a guiding movable rod (15), the guiding movable rod (15) is further connected with a axial radial links (2), two wire ropes (4) passes respectively through all the radial links (3) in both sides of the tire and then couple with two turn buckles (5).

2. The motor vehicle anti-skid crawler according to claim 1, wherein the bifurcated shift-force plate (14) is a triangular cross-sectional body and a triangle body (10) is fixed at the end of the bifurcated shift-force plate (14), wherein the top end of the triangle body (10) is lower than that of the bifurcated shift-force plate (14).

3. The motor vehicle anti-skid crawler according to claim 1, wherein each main shift-force plate (13) have four bifurcated shift-force plates (14) in total, and two bifurcated shift-force plates (14) extended at each end of the main shift-force plate (13) are symmetrically arranged.

4. The motor vehicle anti-skid crawler according to claim 3, wherein the angle between the two bifurcated shift-force plates (14) in each side is between 30 degrees and 150 degrees.

5. The motor vehicle anti-skid crawler according to claim 3, wherein the triangular zone formed among the two bifurcated shift-force plates (14) in each side of the main shift-force plate (13) and the corresponding strength coupling plate (12) is an isosceles triangle.

6. The motor vehicle anti-skid crawler according to claim 1, wherein the main shift-force plate (13) is a trapezoid cross-sectional solid plate body, the top end of the main shift-force plate (13) is provided with a plurality of triangular tooth.

7. The motor vehicle anti-skid crawler according to claim 1, wherein the material of the anti-skid crawler is aluminum alloy, medium-carbon steel or carbon steel.
